(19) United States
(12) Patent Application Publication
(10) Pub. No.: US 2023/0410545 A1
(43) Pub. Date: Dec. 21, 2023

(54) Lidar-based Alert System

(71) Applicant: Bank of America Corporation, Charlotte, NC (US)

(72) Inventors: Neal Aaron Slensker, Fort Mill, SC (US); Bryant Coughlin, Green Bay, WI (US); James Gasper Mathias, Charlotte, NC (US)

(21) Appl. No.: 17/843,273

(22) Filed: Jun. 17, 2022

(51) Int. Cl. G08B 13/196; H04N 7/18; G06V 40/10; G06V 20/52; G01S 17/89

(52) U.S. Cl. CPC G08B 13/196; H04N 7/18; G06V 40/10; G06V 20/52; G01S 17/89

(57) ABSTRACT

Light detection and ranging (LiDAR or lidar) technology may be leveraged to enhance and/or provide additional passive security methods for monitoring facilities and/or devices. A lidar device (e.g., camera, sensor, scanner, and the like) may provide light information that may be processed by a lidar processing server to create a three dimensional map of an area, an object, and/or an individual within the area. For example, the lidar device may monitor activity at a particular location (e.g., a secured entrance, a vestibule including an ATM, and the like), which may include generating a three dimensional image of the monitored area. Additional lidar devices may be used by the lidar processing server to generate a three dimensional image of individuals within a secured area, such as a person approaching a security gate, an individual at or near an ATM, and/or the like.

### BACKGROUND

Organizations utilize video and/or audio capture devices to monitor facilities and/or locations at least for security purposes. For example, organizations may install and/or monitor large numbers of video images and/or streams and/or audio recordings and/or streams, such as those captured by still cameras, video cameras, microphones, closed circuit television (CCTV) cameras and/or other such devices capable of capturing live video, recorded video, still images and/or audio recordings or streams. In some cases, such video and/or audio capture devices may be capable of continuously capturing still images, video recordings, audio recordings and/or streaming video and/or audio. However, even though organizations may have large installed base of cameras and/or audio capture devices located at facilities and/or customer access points (e.g., near cash registers, entrances, exits, automated teller machines, and the like), existing security measures may not capture signs of potential criminal or other nefarious activity captured through existing measures.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In some cases, light detection and ranging (LiDAR or lidar) technology may be leveraged to enhance and/or provide additional passive security methods for monitoring facilities and/or devices. For example, lidar information may be used to provide two-factor authentication for security checkpoints. Additional potential use cases may include self-service transaction devices (e.g. an automated teller machine (ATM)), physical security gates and/or the like. A lidar device (e.g., camera, sensor, scanner, and the like) may process light information to create a three dimensional map of an area and/or an individual. For example, a lidar device may be installed to monitor activity at a particular location (e.g., a secured entrance, a vestibule including an ATM, and the like), which may include generating a three dimensional image of the monitored area. In some cases, one or more lidar devices may be used to generate a three dimensional image of individuals within a secured area, such as a person approaching a security gate, an individual at or near an ATM, and/or the like.

In some cases, a lidar device may create a color image and/or may provide information that may be used to create a three dimensional color image using additional video and/or still camera images. For example, a lidar camera may provide information to generate a three dimensional map of a user (e.g., dimensions, height, hair length, skin reflectivity, and the like). As such, the three dimensional map of the user may be used to capture one or more biometric details of an individual for use as a passive security measure and/or as a quality assurance check. With an individual's identification badge, pin, or other identifier, lidar information may be used as a passive detection measure to determine whether a stolen identification is being used and/or if an unauthorized person is attempting to unauthorized access to a secured location. Additionally, lidar information may be used to create a baseline image of a device, such as a security gate and/or an ATM, such that lidar information may be used to identify whether the device is being or has been improperly modified. For example, static and/or real-time lidar information may be compared to a baseline image to determine whether unauthorized activities have occurred at the device. In some cases, the lidar information may be used to generate a three dimensional image of an ATM, such that lidar images may be analyzed to determine whether a malicious actor has installed a skimmer or other unauthorized device, on the ATM, or to determine whether the ATM has been altered in some fashion. Additionally, lidar information may be leveraged to provide an alert to a user of the ATM, or security personnel, that another individual is physically too close to the user at the ATM.

In some cases, lidar images of devices or areas of a facility may be compared to historical images verified to show one or expected activity or malicious activity. A probability score may be generated for individual lidar images or sequences of lidar images and, for each image or each segment of a lidar sequence of images. If the probability score for the image or sequence of images meet a threshold, then an alert may be generated to identify possible malicious activity at the location of the lidar device capturing the real-time data.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative computing environment implementing a lidar-based alert system in accordance with one or more aspects described herein;

FIG. 2 shows an illustrative process flow for performing lidar-based analysis and alert generation in accordance with one or more aspects described herein;

FIG. 3 shows an illustrative operating environment in which various aspects of the disclosure may be implemented in accordance with one or more aspects described herein;

FIG. 4 shows an illustrative block diagram of workstations and servers that may be used to implement the processes and functions of certain aspects of the present disclosure in accordance with one or more aspects described herein;

FIGS. 5A and 5B show illustrative block diagrams of use of a lidar-based alert system according to one or more aspects described herein; and

FIG. 6 shows an illustrative block diagram of a lidar-based alert system installation according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (i.e., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some example arrangements in which the systems described herein may be used. Various other arrangements employing aspects described herein may be used without departing from the innovative concepts described.

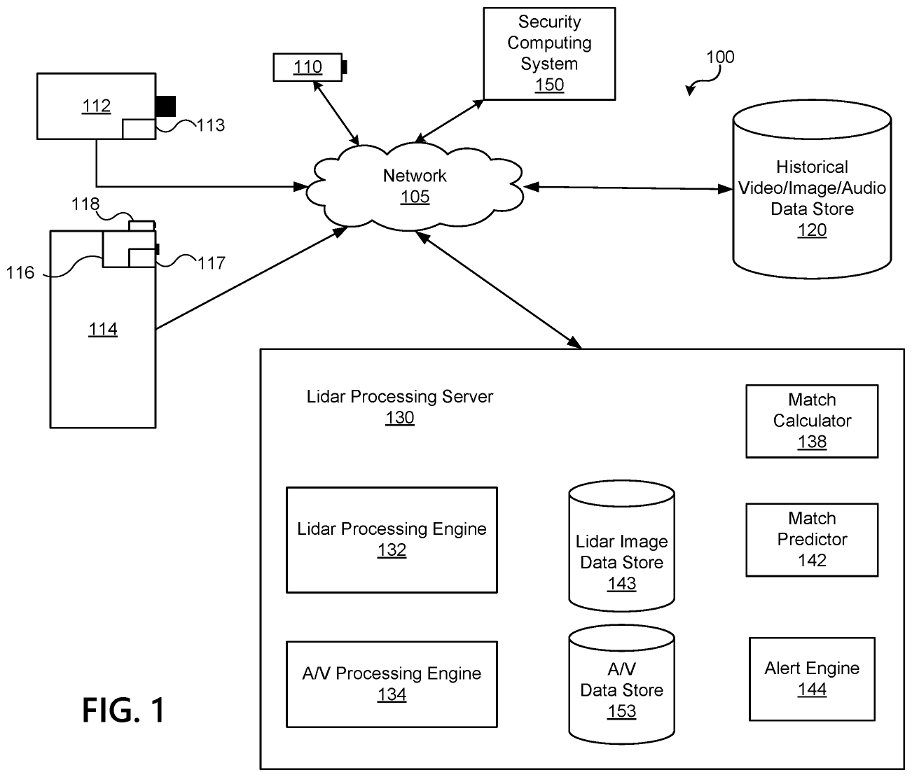

FIG. 1 shows an illustrative computing environment implementing a lidar-based alert system 100 in accordance with one or more aspects described herein. In some cases, the lidar-based alert system 100 may include a lidar processing server 130 communicatively coupled via a network 105 to one or more image capturing devices, video capturing devices, and/or audio capture devices, such as the video cameras 112, 116 and the lidar devices 110 and 118. The lidar-based alert system 100 may further include one or more data stores (e.g., a historical video, lidar image, image, and/or audio data store storing historical or otherwise previously captured video, lidar image, audio and/or image files and associated information such as time information, result information, threat indicator information, activity indication, and/or the like.

Business organizations, enterprise organizations, educational institutions, government agencies and the like may monitor facilities, locations, devices for security purposes and to prevent and/or provide evidence of criminal and/or malicious activities. To do so, one or more still cameras, video cameras, lidar imaging systems, microphones and/or other sensors may be installed to allow for monitoring of facilities or other locations to capture evidence of criminal or malicious activities. For example, a video camera 112 (e.g., a CCTV camera) and/or a lidar imaging device 110 may be installed at a location to capture a video stream (or a series of images), a lidar-based image and an audio stream (or a series of audio clips) via a microphone 113. In some cases, an organization may install a video camera 116, a microphone 117, and/or a lidar imaging device 118 to capture an image sequence, a video stream, a lidar-based image, and/or an audio stream at a location near a device 114, such as an automated teller machine, vending machine, and/or other self-service transaction device. Information captured by the lidar imaging devices 110 and 118 and/or the video cameras 112 and 116, with or without audio information may be communicated to a central location for processing and/or analysis. In some cases, raw lidar, video and/or audio may be stored in a data store with or without additional information, such as a time and date of capture, location information, ranging information, audio information (e.g., volume, amplitude, and the like) and/or other such information and metadata. For example, a data store 120 may store captured or other historical lidar image, video, still image and/or audio files captured by the video cameras 112, 116, lidar devices 110, 118 or other similar devices at one or more locations. In some cases, the data store 120 may store additional metadata that provides information whether the lidar, video, audio and/or image file information is associated with confirmed or suspected criminal or malicious activity. In some cases, the lidar, video, audio and/or image file information may be associated with a baseline condition (e.g., newly installed, normal activity level, or the like) of an area and/or a device. The lidar, video, audio and/or image file metadata may be added or updated by the lidar processing server 130 based on whether the lidar-based image and/or audio/video analysis indicates that at least a portion of a lidar image (with or without corresponding video stream, audio clip, or image sequence information) includes information indicative of criminal or malicious activity, no activity, and/or a baseline activity level. Additionally, the lidar, video, audio or image file metadata may include probability score information other such information describing a likelihood that improper, criminal, and/or malicious activity has been captured in the lidar image(s), video stream, audio stream and/or image sequence. In some cases, feedback may be received from an external security computing system 150 after additional investigation has been performed to update the metadata with confirmation that the lidar image file(s) video file(s), audio file(s) and/or image file(s) have captured an indication of confirmed improper, criminal or malicious activities. For example, the file metadata may include a threat level flag that can be set after confirmation and/or a probability score can be increased above a threshold level or set to 100%. In some cases, the threat level flag may be set to a different level based on an indication of baseline or normal activity levels, such as by clearing the flag and/or setting a probability score under a second threshold level or set to 0.

The lidar processing server 130 may include a lidar processing engine 132, an audio/video (A/V) processing engine 134, a match calculator 138, a match predictor, an alert engine 144 and/or one or more data stores, such as a lidar image data store 143 and an A/V data store 153. Further, the lidar processing server 130 may store instructions in memory that, when processed by a processor, enable the lidar processing server 130 to provide functionality of one or more of the lidar processing engine 132, the A/V processing engine 134, the match calculator 138, the match predictor 142, the alert engine 144 and/or store, modify or retrieve information to/from the lidar image data store 143 and the A/V data store 153. The lidar processing server 130 may analyze lidar, video, image, and/or audio information captured by lidar devices, still cameras, video cameras, microphones, closed circuit television (CCTV) cameras and/or other such devices capable of capturing live lidar, video, recorded video, still images and/or audio recordings or streams. In some cases, the lidar processing server 130, when enabled, may cause one or more lidar devices to begin capturing lidar waveforms.

The lidar processing server 130 may receive or otherwise access live or real-time lidar/audio/video/image feeds via the network 105 from one or more remote devices, such as the video cameras 112, 116 and/or the lidar devices 110 and 118. The lidar processing server 130 may process signals received from the lidar devices 110 and 118, where the lidar devices 110 and 118 may be a discrete return lidar system or a full waveform lidar system. For example, the lidar devices 110 and/or 118 may be a discrete return lidar system and may return a plurality of discrete points, such as a lidar point cloud, such as a raster file format or a compressed file format common supported by the American Society of Photogrammetry and Remote Sensing (ASPRS). In some cases, the lidar devices 110 and 118 a may provide a pulsed laser light to measure ranges (e.g., distances) to a target. The lidar devices may provide one or more beams of laser light and measure a duration before the light returns to the sensor. The lidar devices 110 and 118 may then estimate a height and/or distance to an object or a portion of an object. Discrete lidar data sets may be generated from waveforms corresponding to the returned light energy, where the lidar data sets include points associated with cartesian coordinate system calibrated with respect to the area to be observed. For example, discrete lidar data points may each include an x, y, and z value that may be interpreted to define a topology of a person, device, or geographic area. Additionally, the lidar devices 110 and 118 may provide information that may allow the lidar processing server 130 to infer information about an object's shape, direction of motion and/or speed, and orientation of a moving object. For example, the lidar processing server 130, based on the point data information provided by a lidar device 110, 118 to determine identifying features of a person, a device and/or an area surrounding the person or the device. For example, the lidar processing server may learn details about how nearby objects are positioned, are moving, and/or have been modified. Additionally, the lidar processing server 130 may process information received from the lidar device 110, 118 to generate and/or analyze a three dimensional representation of a surveyed environment. Also, because the lidar device 110 and 118 includes a light source (e.g., the laser), operation is possible in a variety of lighting and/or weather conditions.

A lidar device 110 emits pulsed light waves from a laser into the environment of interest. The pulsed laser energy (e.g., the light waves) reflect from surrounding objects and surfaces before returning to a sensor of the lidar device 110. The time between the light energy emission from the lidar device 110 and return to the sensor may be used to calculate a distance the light energy traveled. By repeating this process, a real-time three dimensional map of the area of interest observed by the lidar device 110 may be created by the lidar device 110, 118 and/or the lidar processing server 130. In some cases, the multiple lidar devices 110, 118 may be used to create an overlapping field of view of the area of interest, such as an ATM and an area surrounding the ATM. In some cases, a resolution of a geospatial map of an object and/or an area surrounding the object may depend on a number of channels (e.g., laser beams) used to produce the geospatial map image.

Cameras produce 2D images of the environment. Lidar “sees” in 3D, a huge advantage when accuracy and precision is paramount. The laser-based technology produces real-time, high-resolution 3D maps, or point clouds, of the surroundings, demonstrating a level of distance accuracy that is unmatched by cameras, even ones with stereo vision. Whereas cameras have to make assumptions about an object's distance, lidar produces and provides exact measurements. For this reason, autonomous or highly automated systems require lidar for safe navigation. The ability to “see” in 3D cannot be underestimated. Lidar produces millions of data points at nearly the speed of light. Each point provides a precise measurement of the environment. Compared to camera systems, lidar's ability to “see” by way of precise mathematical measurements decreases the chance of feeding false information from the vision systems to the car's computer. Additionally, because conventional video camera performance is greatly impacted by environmental conditions (e.g., bright sunlight/glare and darkness), such images may be more susceptible to unpredictable blind spots and generating false positives or negatives when used for identification. However, the lidar devices 110, 118 includes its own laser light source, and can therefore be used in all lighting conditions. Additionally, the lidar devices 110 and 118 may also provide other technological advantages over traditional video cameras that provide two dimensional images. For example, since the three dimensional lidar information (e.g., point clouds) may be used by the lidar processing server 130 to generate one or more views different views of a same geographical area, such as a forward view, an overhead view, and the like. Additionally, the lidar point clouds provided by the lidar devices 110 and 118 may be supplemented with video and/or audio information provided by audio and/or video devices (e.g., camera 112, camera 116, microphone 113, microphone 117 and the like) located and collecting information of a same geographic area. For instance, the color video information captured by cameras 112 and 116 may be used to supplement the lidar information, such as to provide an enhanced color image of individuals and/or objects within the area of interest. Additionally, audio information may be analyzed, along with the lidar information and/or video information, to further provide context for the analyzed lidar information.

Lidar devices 110 and/or 115 may include lasers capable of generating light waveforms of a specified wavelength, such as a wavelength of about 905 nanometers (nm) and/or about 1550 nm. Given the variety of weather conditions that may be encountered in outdoor installations, consideration of laser pulse interaction with water and/or dust may be an important consideration for outdoor or humid environments. As such, when humid conditions are present, or potentiall present, a 905 nm wavelength may be used because 1550 nm wavelengths may be absorbed by water to a much greater extent than 905 nm waves causing 1550 nm waves to be substantially weakened under conditions of rain, fog or snow as compared to shorter (e.g., 905 nm) wavelengths. Conversely, 1550 nm systems may generate higher power laser light to achieve performance comparable to 905 nm systems, such as to offset water absorption and/or ranging differences. As a result, 1550 nm systems may consume more electrical power, and therefore may generate higher heat output which may limit a maximum achievable operating temperature due to the challenge of dissipating the extra heat.

Lidar devices 110 and 118 may be static laser scanners operate as a high-speed station to collect lidar point clouds from a static location. In some cases, the lidar device 110 may be mounted in a position to observe an area of interest as a laser-based ranging and imaging system observing an area of interest and/or a device of interest. Additionally, lidar device 118 may be mounted on a device (e.g., an ATM and/or a security gate) to observe an area adjacent to the device and to observe individuals approaching the device. Additionally, a combination of the lidar devices 110 and 118 may be used to collect lidar point clouds inside buildings (or exterior to the building) where the lidar processing server 130 may combine the information to produce a three dimensional image or model of the area under observation. Additionally, video images (e.g., color images, color video, black and white video, and the like) and audio information may also be used to enhance the three-dimensional image or model of the area of interest, such as to provide a true color, or enhanced resolution, real-time model of the area of interest, with or without corresponding audio captures. Such information may be processed by the lidar processing server 130 to provide real-time security monitoring of objects and/or secure areas.

In some cases, the lidar devices 110, 118 may be one of a number of types of static lidar scanning systems, such as a panoramic scanner, a single axis scanner, and/or a camera scanner. A panoramic scanner may rotate up to 360 degrees around a mounting axis and may scan up to 180 degrees vertically to provide seamless and total coverage of the surroundings. A single axis scanner may also rotate up to 360 degrees but may be have a more limited allowable vertical movement (e.g., between 50-60 degrees, and the like). A camera scanner may point in a fixed direction with limited angular range both horizontally and vertically. Additionally, lidar devices 110 and 118 may be classified according to an operational range, such as a short-range system (e.g., ranges of 50-100 meters with panoramic scanning) that may be used to map building interiors, an area adjacent an object of interest, and/or small objects. A medium range system may operate at distances of 150-250 meters, and may also achieve millimeter accuracies in high definition observation and three dimensional modeling applications, such as for monitoring a secured area adjacent a security gate and/or an object and a large area surrounding the object of interest (e.g., a parking lot adjacent to an outdoor ATM device). A long range system may measure at distances of up to one kilometer and may be used to monitor a larger area from a farther distance, such as to monitor activity near an outdoor vehicle security gate.

In some cases, the lidar processing server 130 may receive a point cloud from one or more lidar devices 110 and/or 118, in near real time, for processing an analysis. The lidar processing server 130 may be positioned local to an installation being monitored, positioned at a regional location to process information from a plurality of locations, or at a central location. In some cases, the lidar processing server 130 may be located local to a building and may be configured to process information from lidar devices 110, 118 and/or A/V devices located in one or more installations at a geographic location. For example, the lidar processing server 130 may be configured to monitor activities near one or more ATMs and a secured area (e.g., a security gate) at a financial institution or office building.

Lidar processing server 130 may process and/or adjust point cloud to classify the point data, such as to identify an object classification (e.g., a door, a hallway, an ATM, a security gate, a vehicle, and/or the like) or individual classification (e.g., a human) is shown in the point cloud information. In some cases, any classified objects or humans may be identified in layers based on spatial coordinates associated with the point data. In some cases, the A/V processing engine 134 may be used to process audio and/or video information that may be incorporated with the lidar point information, such as by the lidar processing engine 132 and/or the A/V processing engine 134. In some cases, the combined point information, or the combined A/V and point information may be processed to identify characteristic information corresponding to a surface of each object or human identified. For example, features on a surface of an ATM may be identified within an identified object, such as a keypad, a card reader, a video screen, and the like. Additionally, characteristic or biometric features of a human may be identified based on the lidar information, such as eye shape, facial features, hair length, facial hair, facial shape, walking gait, and the like may be identified from the real-time point and/or A/V information. In some cases, information corresponding to the identified characteristics of the objects and/or characteristics or biometric features of a human may be stored in a lidar image data store 143 and/or A/V data store 153. In some cases, such as because reflective surfaces may be difficult to image, A/V information may be incorporated into point cloud information supplement any missing information from a reflective surface. In some cases, the lidar devices 110, 118 may provide point clouds corresponding to a single laser or one or more point clouds from multiple lasers incorporated into the device. In some cases, the point cloud may correspond to a point cloud grid.

The lidar processing server 130 may process individual lidar feeds, audio signals or video feeds for individual processing. After processing, one or more of the individual feeds or signals may be combined to form a cohesive representation of an object or area under surveillance. The lidar processing server 130 may associate time and/or sequence information to link the lidar, audio, and video information during analysis. The A/V processing engine 134 may process the real-time video feed, such as by generating a plurality of sequences of images from the video feed. Similarly, the A/V processing engine 134 may process the real-time audio feed, such as by splitting the audio feed into a plurality of sequential audio clips. In some cases, metadata (e.g., time information, location information, video property information, audio property information, and the like) may be associated with sequences of lidar point data provided by the lidar processing engine 132, each image sequence of the plurality of image sequences and each audio clip of the plurality of sequential audio clips. In some cases, a duration of an audio clip under analysis may be aligned with or otherwise equal to a duration associated with an image sequence under analysis and/or a point cloud sequence under analysis. In some cases, the lidar processing server 130 may analyze a number of different lidar/audio/video/image streams in parallel or otherwise concurrently. For example, the lidar processing server may concurrently analyze a real time lidar feed, an image sequence and an audio clip corresponding to a duration of a same real-time video feed and/or lidar feed, as well as historical video and/or audio images captured at the same or similar locations. Sequences of lidar points, images, and audio clips may be linked by a time stamp such that a lidar feed, a video image sequence and a corresponding audio clip from the same duration of the video stream and lidar feed may be analyzed concurrently or nearly simultaneously based on associated time stamps.

The match calculator 138 may calculate a match score based on a comparison between lidar-based three dimensional image from a lidar sequence received from a real-time lidar feed and a historical image retrieved from the data store 120. In some cases, the historical image may be a previous image captured by the same lidar device that captured the lidar stream under analysis. In some cases, the historical image may be an historical image including points of reference and/or a verified identification of criminal or malicious activity, such as an individual verified to have performed a malicious act and/or an object maliciously installed upon a device (e.g., a card skimmer installed on an ATM). The match score may be representative of “sameness” between the two examined lidar images. For example, if a match score is high, then the corresponding probability that the compared lidar images show similar features is greater. If an match score is low, the corresponding probability that compared images show similar features is lesser. Similarly, the match calculator 138 may calculate an A/V score based on a comparison between the audio clip and associated video clip from the input audio signal received from a real-time video feed. In some cases, the historical A/V file may comprise historical audio and/or video from the same video sequence as the analyzed image and/or may include audio and/or video verified as representative of criminal or malicious activity. The match score may be representative of “sameness” between the two examined A/V files. For example, if a match score is high, then the corresponding probability that the compared A/V files include similar A/V features is greater. If an match score is low, the corresponding probability that compared A/V files include similar A/V features is lesser. In some cases, the match calculator 138, the lidar processing engine 132 and/or the A/V processing engine may perform some sort of error correction on the converted real-time lidar clips, audio clips and/or converted real-time image files (e.g., video files), and/or on converted historical lidar files, audio files and/or image files. The error correction may be used to protect the converted information from errors due to noise that may be introduced into the combined lidar and A/V files. Error correction may be used to achieve a fault-tolerant comparison engine that overcome noise on stored lidar information, but with other errors that may be introduced due to erroneous lidar processing techniques, problematic lidar returns for reflective surfaces, and/or issues with video or audio capture. Error correcting codes that may be used include, but are not limited to a lidar error correction method based on a Bayesian network.

The match predictor 142 may analyze the match score associated with an analyzed lidar file and/or the match score associated with an A/V clip file to determine a probability that the lidar file and/or the A/V clip file includes indications of criminal or malicious activity. A higher probability score may correspond to a higher likelihood that a particular lidar and/or A/V clip includes an indication of criminal or malicious activity. In some cases, the match predictor 142 may update a probability score associated with a sequence of lidar images. For example, when a lidar signal (e.g., real time lidar point information) received from a lidar device 110, 118 and/or an A/V signal of an incoming real-time video signal received from a video camera 112, 116, the lidar signal and A/V signal may be split into a sequence of lidar clips, audio clips and video clips. Each lidar clip may be associated with a corresponding audio and/or video clip associated with a same duration of the real-time lidar signal. For analysis, each lidar clip and/or video clip may be further split into a sequence of images, where each image of the sequence of images may be analyzed individually. In some cases, the lidar images and video images may be merged into a combined three dimensional image. In some case, the match predictor 142 may determine a probability score associated with each lidar images and a probability score associated with the sequence of lidar images. In some cases, the probability score for a sequence of lidar images may be calculated as a sum of the probability score for each lidar image of the sequence of lidar images, a weighted sum of the probability score for each image of the sequence of lidar images and/or using another algorithm or function. In some cases, the probability score may be enhanced based on a sum or weighted sum (or using another function or algorithm) of a probability score of the audio clip and the corresponding sequence of images.

The lidar processing server 130 may then analyze the probability score to determine whether an incoming real-time lidar and/or video stream includes indications of criminal or malicious activity. For example, the lidar processing server 130 may enable the alert engine 144 to compare a probability score of a lidar clip to one or more lidar thresholds, a probability score of an A/V file to one or more A/V thresholds, a probability score of a lidar image sequence to one or more sequence thresholds, and/or a combined probability score of a lidar clip and an A/V clip to one or more combined thresholds. In some cases, the one or more thresholds may be used to indicate a high probability that criminal or malicious activity is occurring in real-time with the lidar analysis of the real-time lidar signal. In some cases a high threshold (e.g., about 80% to about 90%) may indicate a high probability that criminal or malicious activity is happening in real time, a medium threshold (e.g., about 70% to about 80%) may indicate that criminal or malicious activity may be occurring, but additional investigation may be required.

In cases when an alert meets a threshold, the alert engine 144 may initiate one or more alarm sequences that may include locking of doors in the vicinity of the lidar device, disabling of one or more devices (e.g., disabling operation of a self-service transaction device 114 based on an indication that potential tampering has been identified), initiating an visual and/or audio alarm in the vicinity of the lidar device 110, 118 that is the source of the analyzed real-time lidar feed, and/or sending an alert to a security or law enforcement computing system indicating a real-time indication of criminal or malicious activity has been captured in three dimensions and/or video and may include a geographic location, a time stamp and/or other information associated with the lidar device, video camera, A/V feed and/or lidar feed. In some cases, an alert message may include a copy of the analyzed lidar clip and/or video clip. In some cases, the alert engine 144 may receive feedback based on whether an alert was sent or not sent and may include an indication of the feedback as metadata associated with an archived copy of the incoming lidar feed that may be stored in the data store 120. In some cases, the feedback may include an indication that the alert was correctly issued, an indication that the alert was incorrectly indicated, an indication that the alert corresponded to an emergency condition, and/or the like. In some cases, the alert engine may generate a message to an internal security team to further analyze a lidar clip, a video image and/or audio clip, such as when the probability score is near to matching a lowest threshold level. In some cases, lidar processing server 130 may be configured to identify an indication that an individual may be experiencing a health-related emergency in a similar manner as described above. The alert engine 144 may communicate an alert message via an emergency alert system when the match predictor identifies an indication of a health-related emergency.

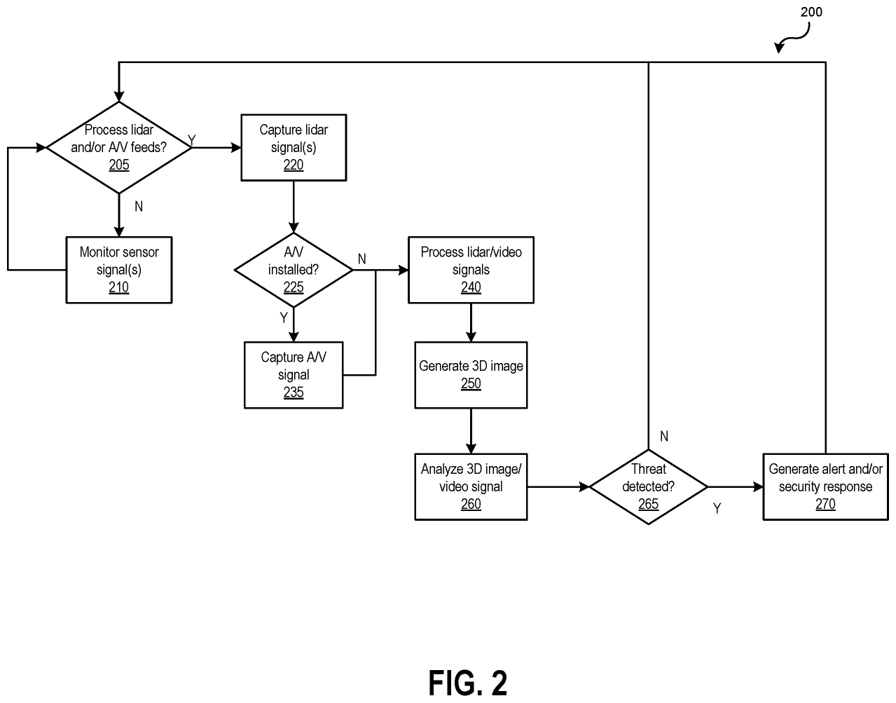

FIG. 2 shows an illustrative process flow 200 for performing lidar-based analysis and alert generation in accordance with one or more aspects described herein. In some cases, the lidar processing server 130 may continuously process lidar feeds and/or AV feeds monitoring an area or object of interest. In some cases, the lidar processing server 130 may begin monitoring and/or processing of the lidar feeds and/or A/V feeds periodically or upon receipt of a sensor input. At 205, the lidar processing server 130 may determine whether to begin processing lidar and/or A/V signals. If an input is not received, such as from a proximity sensor or other indicator that activity is occurring in the area of interest or near an object of interest, the lidar processing server 130 continues monitoring for sensor signals at 210. If, at 205, the lidar processing server 130 identifies that no sensor is installed (e.g., continuous monitoring is configured), receives an input (e.g., a proximity sensor indicates movement in an area of interest, and the like), or a periodic monitoring period (e.g., 1 minute, 30 minutes, 1 hour, and the like), the lidar processing server 130 may begin capturing lidar signals for monitoring at 220. For example, when the lidar processing server 130 is configured for real-time monitoring, the lidar processing server 130 may continuously receive lidar signals from one or more of the lidar devices 110, 118. In some cases, when triggered by expiration of a waiting period or a proximity sensor input, the lidar processing server 130 may process lidar and/or A/V signals in real time for a specified duration of time (e.g., 5 minutes, 30 minutes, 1 hour, and the like), an indication that an individual has left the area of interest (e.g., a second proximity sensor input) or until a proximity sensor indicates that no movement has occurred within the target area for a period of time (e.g., 1 minute, 5 minutes, 10 minutes or the like).

At 220, the lidar processing server 130 captures and/or receives real time, or sampled, lidar signals from one or more lidar devices 110, 118 to be processed by the lidar processing engine 132 and to be stored, processed and/or unprocessed in a lidar image data store 143. Additionally, the lidar processing server 130 may determine, at 225, whether video and/or audio signals are available for analysis. For example, a configuration setting or input may be used to identify whether one or more A/V devices (e.g., video cameras, still image cameras, microphones, closed circuit video cameras, and the like) are communicatively coupled to the lidar processing server 130. If so, A/V feeds may be captured and/or sampled in real time at 235, such as from the cameras 112 and 116 and the microphones 113 and 117. If at 225, no A/V devices were available, the lidar signals may be processed, in real time, by the lidar processing engine 132 at 240. Similarly, if A/V devices are present and captured at 235, the lidar processing engine 132 and the A/V processing engine 134 may process the lidar signals and A/V signals, respectively. At 250, the lidar processing engine 132 may generate an enhanced three dimensional image of the geographic area and/or object under observation based on point cloud information received from the lidar device 110, 118 and store the three dimensional image in the lidar image data store 143 with associated metadata comprising time information, date information and the like. Additionally, the A/V processing engine 134 may process the audio and/or video signals from the video feed captured concurrently with the lidar feed. the lidar processing engine 132 may then enhance real time lidar image information with corresponding audio and/or video information processed by the A/V processing engine 134. In some cases, the video information may be used to generate a real-color three dimensional image sequence corresponding to the lidar point cloud. In some cases, the A/V processing engine 134 may extract a real-time audio stream from the real-time video stream to provide an isolated real-time audio stream and an isolated real-time video stream and store the isolated A/V streams in the A/V data store 153, along with corresponding metadata.

At 260, the match calculator 138 and match predictor 142 may analyze the real-time lidar and/or A/V images for indications of malicious or criminal activity. In some cases, the match calculator and/or match predictor may access historical lidar and/or A/V images and/or audio files corresponding to verified indications of criminal or malicious activity. The match calculator 138 may calculate a match score based on a pixel by pixel (or point by point) comparison between a captured (or enhanced) lidar image or image sequence and a historical image. The match predictor 142 may generate a probability of criminal activity based on the snapshot match score. For example, if the match score is above a specified threshold a probability score may be assigned based on an amount above or below the threshold. In some cases, the probability score may be calculated based on a formula corresponding to the match score based on three dimensional matching algorithms. In some cases, a probability score of a lidar image sequence (corresponding to a real-time lidar feed) may be updated based on a probability score of the currently analyzed image, such as by summing the probability scores, averaging the probability scores, calculating a weighted sum or weighted average of the probability scores for all images in the lidar image sequence. In some cases, a combined probability score may be determined by determining an audio probability score based on a separate audio analysis and/or a video probability score based on a separate video analysis. At 265, the lidar image sequence threshold may be analyzed to determine whether one or more thresholds have been met. For example, if a low threshold condition has been met or no threshold condition has been met, a next lidar image of the lidar image sequence may be selected and the video analysis sequence repeats until the all images of a particular image sequence has been analyzed. If at, 255 a probability threshold has been met, an alert may be generated by the alert engine at 256. Optionally or additionally, at 265 a higher probability threshold condition has been met (e.g., above about 90%) then an alert or security response may be generated at 270.

In some cases, the alert may be an audio and/or visual alarm at the lidar device location, an emergency message sent to a law enforcement facility near the vicinity of the lidar device, an alert to building security at which the lidar device is located, or the like. In some cases, the lidar image and/or A/V sequence may be included in the alert, or linked for remote viewing by responsible parties, emergency personnel, and/or security personnel. In some cases, if the alert is validated, the captured lidar, video, and/or audio may be added to the historical image data store for future comparisons.

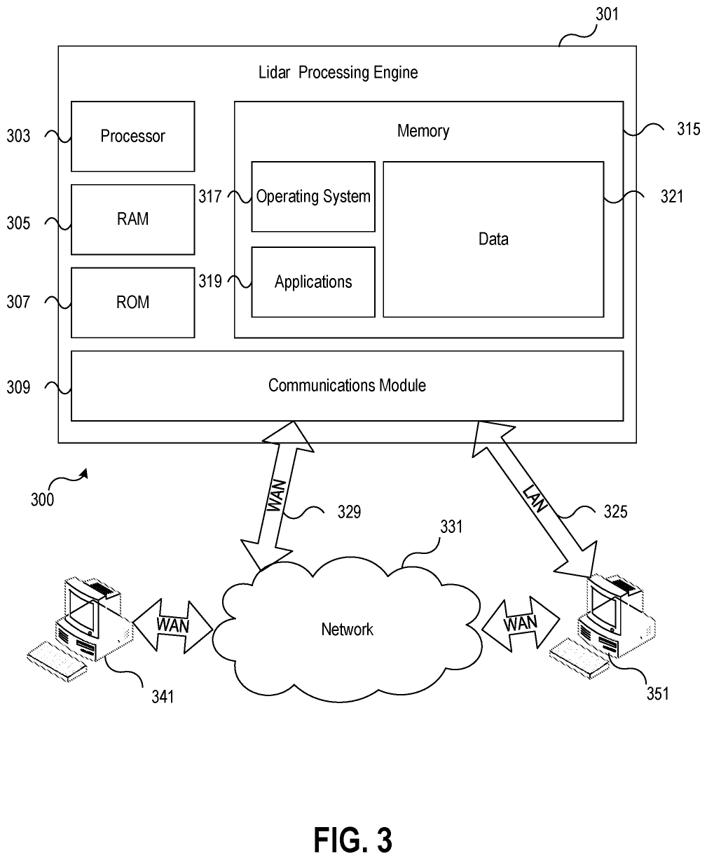

FIG. 3 shows an illustrative operating environment in which various aspects of the present disclosure may be implemented in accordance with one or more example embodiments. Referring to FIG. 3, a computing system environment 300 may be used according to one or more illustrative embodiments. The computing system environment 300 is only one example of a suitable computing environment and is not intended to suggest any limitation as to the scope of use or functionality contained in the disclosure. The computing system environment 300 should not be interpreted as having any dependency or requirement relating to any one or combination of components shown in the illustrative computing system environment 300.

The computing system environment 300 may include an illustrative lidar processing engine 301 having a processor 303 for controlling overall operation of the lidar processing engine 301 and its associated components, including a Random-Access Memory (RAM) 305, a Read-Only Memory (ROM) 307, a communications module 309, and a memory 315. The lidar processing engine 301 may include a variety of computer readable media. Computer readable media may be any available media that may be accessed by the lidar processing engine 301, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by the lidar processing engine 301.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed by the processor 303 of the lidar processing engine 301. Such a processor may execute computer-executable instructions stored on a computer-readable medium.

Software may be stored within the memory 315 and/or other digital storage to provide instructions to the processor 303 for enabling the lidar processing alert engine 301 to perform various functions as discussed herein. For example, the memory 315 may store software used by the lidar processing engine 301, such as an operating system 317, one or more application programs 319, and/or an associated database 321. In addition, some or all of the computer executable instructions for the lidar processing engine 301 may be embodied in hardware or firmware. Although not shown, the RAM 305 may include one or more applications representing the application data stored in the RAM 305 while the lidar processing engine 301 is on and corresponding software applications (e.g., software tasks) are running on the lidar processing engine 301.

The communications module 309 may include a microphone, a keypad, a touch screen, and/or a stylus through which a user of the lidar processing engine 301 may provide input, and may include one or more of a speaker for providing audio output and a video display device for providing textual, audiovisual and/or graphical output. The computing system environment 300 may also include optical scanners (not shown).

The lidar processing engine 301 may operate in a networked environment supporting connections to one or more remote computing devices, such as the computing devices 341 and 351. The computing devices 341 and 351 may be personal computing devices or servers that include any or all of the elements described above relative to the lidar processing engine 301.

The network connections depicted in FIG. 3 may include a Local Area Network (LAN) 325 and/or a Wide Area Network (WAN) 329, as well as other networks. When used in a LAN networking environment, the lidar processing engine 301 may be connected to the LAN 325 through a network interface or adapter in the communications module 309. When used in a WAN networking environment, the lidar processing engine 301 may include a modem in the communications module 309 or other means for establishing communications over the WAN 329, such as a network 331 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

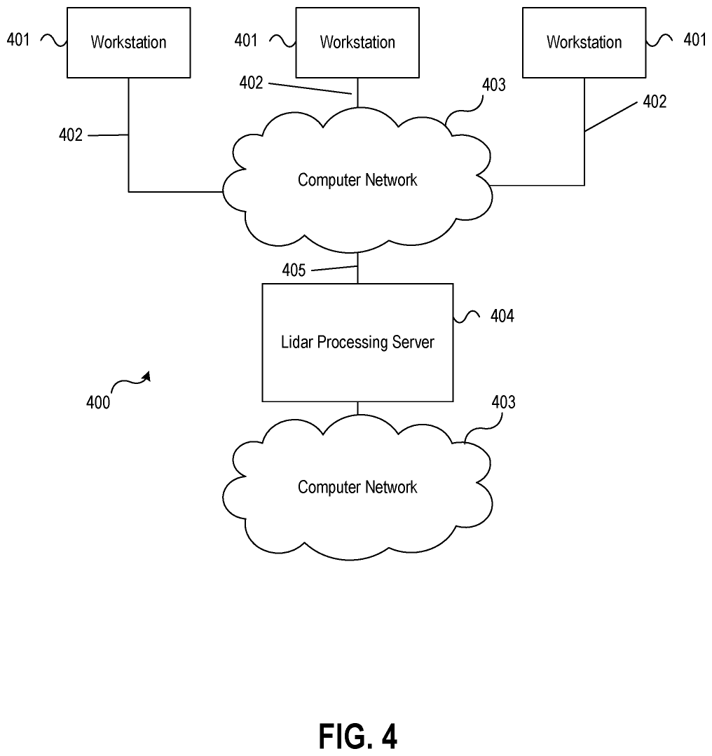

FIG. 4 shows an illustrative block diagram of workstations and servers that may be used to implement the processes and functions of certain aspects of the present disclosure in accordance with one or more example embodiments. For example, an illustrative system 400 may be used for implementing illustrative embodiments according to the present disclosure. As illustrated, the system 400 may include one or more workstation computers 401. The workstation 401 may be, for example, a desktop computer, a smartphone, a wireless device, a tablet computer, a laptop computer, and the like, configured to perform various processes described herein. The workstations 401 may be local or remote, and may be connected by one of the communications links 402 to a computer network 403 that is linked via the communications link 405 to a lidar processing server 404. In the system 400, the lidar processing server 404 may be a server, processor, computer, or data processing device, or combination of the same, configured to perform the functions and/or processes described herein. The lidar processing server 404 may be used to monitor real-time audio and/or video signals captured live at an enterprise facility and may perform real time analysis of the signals via quantum computing entanglement with verified historical video and/or audio signals that show suspected criminal or malicious activity.

The computer network 403 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. The communications links 402 and 405 may be communications links suitable for communicating between the workstations 401 and the lidar processing server 404, such as network links, dial-up links, wireless links, hard-wired links, as well as network types developed in the future, and the like.

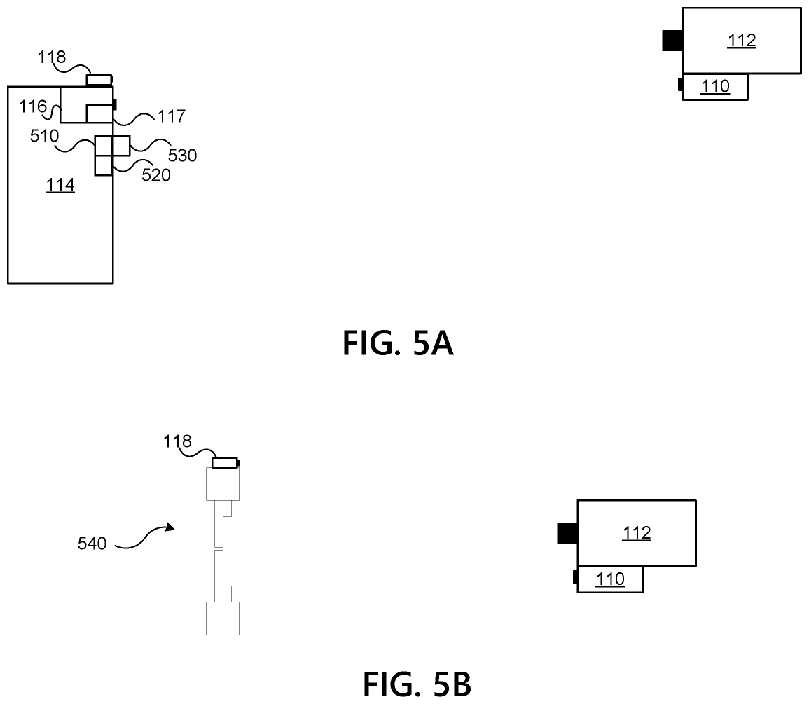

FIGS. 5A and 5B show illustrative block diagrams of use of a lidar-based alert system according to one or more aspects described herein. For example, FIG. 5A shows lidar-based alert system monitoring an ATM installation and FIG. 5 B shows a lidar-based alert system monitoring a security gate. While, FIGS. 5A and 5B show multiple lidar devices, video cameras and/or microphones, any combination of the above may be combined with a single lidar device.

In FIG. 5A, a lidar device 110 may be installed monitoring an area including the ATM 114. Here, the lidar device 110 is shown co-mounted with a video capture device (e.g., camera 112), but may be installed alone or with additional devices. Additionally, the ATM 114 may include a video camera 116, a microphone 117, where the lidar device 118 may be separately mounted on an exterior of the ATM 114 or may be integrated into the housing of the ATM. In this example, the lidar device 118 (with or without supplemental video feeds captured by the ATM camera 116) may be used to monitor an area adjacent to the front of the ATM 114. As such, by combining the lidar feeds of the lidar device 118 and 110, the lidar processing server 130 may generate a three dimensional lidar image feed of an entire area adjacent to the ATM 114. As such, the lidar processing server 130 may be able to identify individuals using the ATM 114, approaching the ATM 114 and/or users using the ATM 114, and the like. Because multiple lidar devices may be installed in a space, the lidar processing server 130 may combine the lidar feeds (with or without additional A/V feeds) to generate a three dimensional representation of the area under observation and the objects and/or individuals within the area.

In FIG. 5A, the ATM 114 may include a card reader 510 and a keypad 520, where the lidar device 110 may provide an image feed over time such that the lidar processing server 130 may identify changes to an exterior of the ATM 114. For example, the lidar processing server 130 may compare historical images of the ATM 114 to current images of the ATM 114 to identify whether an external object 530 may have been maliciously installed onto the ATM 114. In some cases, the lidar processing server 130 may identify the external object 530 as card skimmer, even if the card skimmer is camouflaged to appear similar to the look of the card reader 510. For example, the lidar processing server may identify that the card reader extends farther than previously observed, based on an analysis of the three dimensional image of the ATM surface. In other cases, the lidar processing server 130 may compare three dimensional images to identify whether a camera or other device has been installed to observe entry of personal identifiers (e.g., a personal identification number (PIN) or the like). In some cases, the lidar processing server 130, in response to identification of an exterior modification to the ATM 114, such as installation of an external object, damage to the ATM 114, or the like, the lidar processing server 130 may identify an individual performing the modification or damaging the ATM. For instance, after the lidar processing server 130 identifies an exterior modification (e.g., addition of the external object 530 and/or identification of exterior damage) of the ATM 114, the lidar processing server 130 may analyze historical lidar feeds and/or images captured before the exterior modification was observed. Based on the analysis of the historical lidar feeds and/or images, the lidar processing server 130 may identify an individual observed immediately before identification of the exterior modification, where identifying features may be extracted from the lidar feed of the lidar device 118 and/or from the remote lidar device 110 as the individual approaches the ATM 114, applies the exterior modification, and/or exits the area after performing the modification to the ATM 114.

FIG. 5B shows one or more lidar devices 110 and/or 118 installed observing actions at or near a security gate 540. In some cases, one or more video cameras 112 may be installed to supplement the lidar feeds of the lidar devices 110 and/or 118. Here, individuals approaching a security gate, such as separating secured areas from publicly accessible areas in buildings, transit locations (e.g., subways, train stations, and the like), sports stadiums, and the like. Here, the lidar device 118 may be co-located at the site of the security gate, such that the lidar device 118 may capture individuals approaching or leaving the security gate 540. Additionally, the lidar device 110, and/or the video device 112, may capture lidar feeds and/or A/V feeds of the security gate to capture actions within the vicinity of the security gate 540. As discussed above, the lidar processing server 130 may analyze the lidar feeds captured by the lidar devices 118 and/or 110, with or without an additional A/V feed from the video camera 112, to identify unusual and/or malicious activities at the security gate, such as actions to damage the security gate 540 and/or to identify individuals who attempt to bypass the security measures provided by the security gate 540. In some cases, the lidar processing server 130 may additionally receive a feed from a card reader or other credential monitoring device installed at the security gate, such that the lidar processing server may compare a three dimensional image of a user of a security card captured by the one or more lidar devices 118 and 110 to an image of the user associated with the card. In some cases, when a difference is observed, the lidar processing server 130 may trigger a security response, where an alert message may include the captured images. In some cases, the lidar processing server 130 may identify when individuals attempt to bypass the security gate 540 without use of a security access credential, such as by jumping over the security gate 540. Here, the lidar devices 110 and 118 may be processed by the lidar processing server 130 to provide a three dimensional image of the individual(s) approaching, bypassing, and exiting the area of the security gate 540, with sufficient three dimensional details to facilitate identification of the individuals.

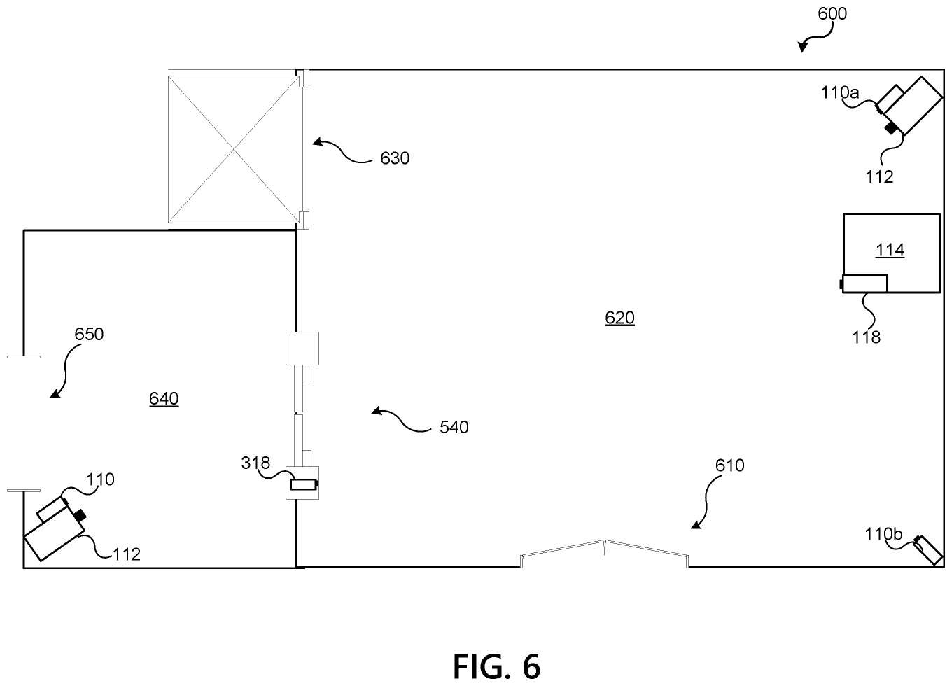

FIG. 6 shows an illustrative block diagram of a lidar-based alert system installation 600 according to one or more aspects described herein. Here, the lidar-based alert system installation 600 may be installed to observe and/or monitor activities within a publicly accessible area 620 and a secured area 640. Individuals may enter the publicly accessible area 620 vi a doorway 610, where the doorway 610 may be a doorway to a public sidewalk or a parking lot. Individuals may exit the publicly accessible area 620 via the doorway 610, an elevator 630 and/or a security gate 540. The security gate 540 may provide a secured entry and/or exit from a secured area 640 that may include a doorway 650 to additional areas of a building. In some cases, the elevator 630 may provide unsecured or secured access to additional floors of a building, where secured access may be maintained via keypad-based or access card-based security measures.

In some cases monitoring of the publicly accessible area 620 and/or the secured area 640 may be continuous or, in some cases, may begin upon detection of movement within the publicly accessible area (e.g., an opening of the door of the doorway 610, opening of the elevator 630 and/or entry of an individual into the adjacent secured area 640, such as via the doorway 650. Such detection may be provided by one or more sensors including, but not limited to, proximity sensors, motion sensors, and/or the like. In some cases, the lidar processing server 130 may monitor one or more lidar feeds including an entryway (e.g., the doorway 650, the doorway 610, the elevator 630, and the like) within a field of view of one or more lidar devices 110, 118, 318. Here, the lidar processing server may monitor images of the publicly accessible area 620 and/or the secured area 640 for changes indicating an individual has entered the monitored space. Upon triggering, the lidar processing server 130 may analyze lidar and/or A/V feeds for indications of malicious and/or criminal activity. In some cases, the lidar devices 110, 118, and 318 may communicate lidar signals to the lidar processing server 130, along with one or more A/V feeds from one or more cameras 112. The lidar processing server 130 may build a baseline three dimensional model detailing the features of the static objects within the publicly accessible area 620 and/or the secured area 640. The three dimensional model may be used in real time to determine differences from the baseline during monitoring to identify real time instances of malicious or criminal activity.

As shown, one or more lidar devices 110 and/or video cameras 112, may be installed to monitor activities within the publicly accessible area 620, where the lidar processing server 130 may be communicatively coupled via a network to process lidar feeds and/or A/V feeds to monitor activities and/or issue alerts as needed. In some cases, lidar devices 118 and/or 318 may also provide lidar feeds that may be used to monitor activities within the publicly accessible area 620. Lidar devices 110 may provide lidar feeds that may be used for monitoring multiple devices, entryways, and/or exits. For example, lidar device 110a may provide a lidar feed including the elevator 630, the security gate 540 (along with at least a partial view of the secured area 640), the ATM 114, and the doorway 610. Similarly, the lidar device 110b may provide a lidar feed including the ATM 114, the elevator 630, the security gate 540 (along with at least a partial view of the secured area 640), and/or at least a partial view of the doorway 610. Similarly, the lidar devices 118 and/or 318 may provide a lidar feed that may be used to identify individuals approaching the ATM or security gate, respectively, but may also be used to monitor one or more of the publicly accessible area 620 and/or the secured area 640 In some cases, lidar feeds from one or more lidar devices 110, 118, 318 may be used to monitor other lidar devices within the field of view, such that the lidar processing server 130 may identify tampering attempted of these devices.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A method comprising:
receiving, by a lidar processing server, at least one lidar feed from a lidar device, wherein the lidar feed provides three dimensional details of objects within a field of view;
extracting, from the lidar feed, real-time three dimensional characteristics of an object of interest;
determining, based on historical lidar information, whether a change has occurred to at least one characteristic of the object of interest; and
triggering, based on an indication the change of the object of interest, display of a notification detailing the change to the at least one characteristic of the object of interest.

2. The method of claim 1, wherein the object of interest is an automatic teller machine (ATM) and the at least one characteristic of the ATM comprises a card reader and wherein the change to the card reader is an installation of an unauthorized card reading device.

3. The method of claim 1, wherein the at least one lidar feed comprises a signal generated by a lidar device co-located with the object of interest.

4. The method of claim 1, wherein the at least one lidar feed comprises a signal generated by a lidar device remote from the object of interest, wherein the object of interest lies within a field of view of the lidar device.

5. The method of claim 4, further comprising:
receiving, from a video capture device, a video feed of the object of interest; and
generating, by the lidar processing server based on the lidar feed and the video feed, a real-color image of the object of interest.

6. The method of claim 1, wherein the object of interest is an automatic teller machine (ATM), and further comprising:
determining, based on the lidar feed, an identification of a user of the ATM; and
generating, based on the identification of the user, an alert when an image of the user fails to match a secure identifier of the user.

7. The method of claim 6, wherein the secure identifier of the user comprises a biometric identifier of the user.

8. A computing device comprising:
a processor; and
non-transitory memory storing instructions that, when executed by the processor, cause the computing device to:
capture, in real time, lidar information captured by at least one lidar device;
monitor, in real time based on a lidar stream received from the at least one lidar device, activities within a field of view of the at least one lidar device;
identify, in real time and based on a historical record of activities within the field of view of the at least one lidar device, an indication of a malicious activity;
communicate, in real time, an alert corresponding to an identified indication of a malicious activity within the field of view of the at least one lidar device.

9. The computing device of claim 8, wherein an object of interest within the field of view of the lidar device is an automatic teller machine (ATM) and wherein the identified indication of a malicious activity comprises an installation of an unauthorized card reading device at the ATM.

10. The computing device of claim 8, wherein the at least one lidar feed comprises a signal generated by a lidar device co-located with an object of interest.

11. The computing device of claim 8, wherein the at least one lidar feed comprises a signal generated by a lidar device remote from an object of interest, wherein the object of interest lies within a field of view of the lidar device.

12. The computing device of claim 11, wherein the instructions further cause the computing device to:
receive, from a video capture device, a video feed of an object of interest within the field of view of the lidar device; and
generate, by the lidar processing server based on the lidar feed and the video feed, a real-color image of the object of interest.

13. The computing device of claim 8, wherein an object of interest within the field of view of the lidar device is an automatic teller machine (ATM), and wherein the instructions further cause the computing device to:
determine, based on the lidar feed, an identification of a user of the ATM; and
generate, based on the identification of the user, an alert when an image of the user fails to match a secure identifier of the user.

14. The computing of claim 13, wherein the secure identifier of the user comprises a biometric identifier of the user.

15. The computing device of claim 8, wherein an object of interest within the field of view of the lidar device is an automatic teller machine (ATM), and wherein the instructions further cause the computing device to:
determine, based on the lidar feed, an identification of a user of the ATM;
determine, based on the lidar feed, a distance between the user of the ATM a second individual near the user; and
generate, based on the distance between the user of the ATM and the individual, an alert.

16. The computing device of claim 15, wherein the instructions, further cause the computing device to:
determine, based on the lidar feed, an identification of the second individual; and
initiate, based on a match between the identification of the second individual and a historical record of individuals previously determined to perform malicious activity near the ATM, a security response.

17. The computing device of claim 16, wherein the security response comprises generation of a message to security personnel, the message comprising a location of the ATM and a lidar image of the second individual captured by the at least one lidar device.

18. The computing device of claim 15, wherein the instructions, further cause the computing device to:
determine, based on the lidar feed, an identification of the second individual;
determine, based on the lidar feed, an identification of an object held by the second individual; and
generate, based on a match between the object and a record of dangerous objects, a security response.

19. The computing device of claim 18, wherein the security response comprises generation of a message to a local law enforcement office, the message comprising location information of the ATM and a lidar image of the second individual generated by the lidar processing device.

20. The computing device of claim 8, wherein an object of interest within the field of view of the lidar device is a security gate, and wherein the instructions further cause the computing device to:
determine, based on the lidar feed, an identification of an individual adjacent to the security gate; and
generate, based on the identification of the individual, an alert when the identification of the individual fails to match a secure identifier that the individual uses in an attempt to proceed through the security gate.
